(19) United States
(12) Patent Application Publication
(10) Pub. No.: US 2010/0241793 A1
(43) Pub. Date: Sep. 23, 2010

(54) STORAGE SYSTEM AND METHOD FOR CONTROLLING STORAGE SYSTEM

(75) Inventors: Sadahiro Sugimoto, Kawasaki (JP); Akira Yamamoto, Sagamihara (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Chiyoda-ku, Tokyo (JP)

(21) Appl. No.: 12/596,118

(22) PCT Filed: Mar. 26, 2009
(86) PCT No.: PCT/JP2009/001359

§ 371 Date: Oct. 15, 2009

(30) Foreign Application Priority Data
Apr. 25, 2008 (JP) 2008-114773

(51) Int. Cl. G06F 12/02; G06F 12/16

(52) U.S. Cl. 711/103; 711/114; 711/E12.008; 711/E12.103

(57) ABSTRACT

The present invention efficiently uses the storage capacity in a storage system that has flash memory as a storage medium.

A storage system has a storage controller and a flash memory module that is connected to the storage controller. The storage controller manages the status of a storage area in a flash memory chip of the flash memory module. When a portion of the storage area in the flash memory chip becomes unwritable, the storage controller carries out control so as to use a free storage area as an alternate area for the unwritable storage area, and to store data that has been stored in the unwritable storage area, in the alternate area.

### TECHNICAL FIELD

The present invention relates to a storage system, and more particularly to a storage system that uses a nonvolatile semiconductor memory such as a flash memory, and to a method for controlling a storage system.

### BACKGROUND ART

Storage devices that use flash memory and other such nonvolatile semiconductor memory in place of conventional hard disk devices have been attracting attention in recent years. Compared to a hard disk, a flash memory has the advantages of being able to operate at high speed and consuming less power, but, on the other hand, flash memory also has the following restrictions. First, the updating of the respective bits of memory is limited to one direction, that is, from 1 to 0 (or from 0 to 1). When a reverse change is required, it is necessary to delete a memory block (hereinafter called the “block”) and make the entire block 1's (or 0's) one time. Further, there is a limit to the number of times this deletion operation can be carried out, and in the case of a NAND-type flash memory, for example, this limit is somewhere between 10,000 and 100,000 times.

Thus, connecting a flash memory to a computer in place of a hard disk device runs the risk of the write frequency bias of each block resulting in only a portion of the blocks reaching the limit for number of deletions and becoming unusable. For example, since the blocks allocated to the directory or mode have a higher rewrite frequency than the other blocks in an ordinary file system, there is a high likelihood that only these blocks will reach the limit for number of deletions.

With regard to this problem, a technique that extends the life of a storage device by allocating an alternate memory area (alternate block) to a memory area that has become unusable (a bad block) as disclosed in Patent Literature 1 is known.

### CITATION LIST

### Patent Literature

### [PTL 1]

Japanese Patent Application Laid-open No. H5-204561

### SUMMARY OF INVENTION

### Technical Problem

However, applying the technique disclosed in Patent Literature 1 does not make it possible to extend the life of a storage device indefinitely, and when the memory areas, which were provided beforehand in the storage device, and which are capable of being allocated as alternate blocks run out, the storage device will reach the end of its service life.

When configuring a storage system using a storage device that makes use of a flash memory like this in place of a hard disk, a storage device that has reached the end of its service like must be replaced with a new storage device. Because of the bias in the frequency of writes from the host computer, it can be assumed that a large number of usable blocks remain in a storage device that has reached the end of its life, but these usable blocks are discarded at replacement time, resulting in this portion of the flash memory capacity being wasted. Furthermore, the need to replace a semiconductor disk can be eliminated by mounting beforehand in the storage device the maximum amount of spare blocks capable of being used as alternate blocks while the storage system is in operation, but in addition to the increase in initial costs, the concern is that these spare blocks will not be completely used up during actual operation, and thus become a waste.

Therefore an object of the present invention is to provide a technique that makes it possible to reduce the waste described hereinabove by making efficient use of the flash memory capacity when a flash memory is applied to a storage system.

### Solution to Problem

The storage system has a storage controller, and a flash memory module that is connected to the storage controller. The storage controller manages the status of the storage area in a flash memory chip of the flash memory module. When it becomes impossible to write to a portion of the storage area in the flash memory chip, the storage controller exercises control such that a free storage area is used as an alternate area for a storage area that has become unwritable, and the data stored in the unwritable storage area is stored in the alternate area.

### Advantageous Effects of Invention

In a storage system equipped with flash memory, even when a portion of the storage area of the flash memory becomes unusable, it is possible to continue using the other areas without discarding the entire flash memory, thereby enabling efficient use of the flash memory capacity.

### BRIEF DESCRIPTION OF DRAWINGS

FIG. 1 is a diagram showing an example of the configuration of a storage system.

FIG. 2 is a diagram showing an example of block management information in Example 1.

FIG. 3 is a diagram showing an example of an alternate block allocation method of Example 1.

FIG. 4 is a diagram showing an example of a management server GUI of Example 1.

FIG. 5 is a flowchart showing an example of a process in which the management server of Example 1 checks the free block capacity in the storage system, and displays a warning message.

FIG. 6 is a flowchart showing an example of a process in which a microprocessor of a storage device of Example 1 checks the free block capacity and sends a warning message to the management server.

FIG. 7 is a conceptual view showing an example of a RAID1 configuration in Example 2.

FIG. 8 is a diagram showing an example of an alternate block allocation method of Example 2.

FIG. 9 is a diagram showing an example of a management server GUI of Example 2.

FIG. 10 is a diagram showing an example of block management information in Example 2.

FIG. 11 is a flowchart showing an example of a destage process of Example 2.

FIG. 12 is a flowchart showing an example of a rebuild process of Example 2.

FIG. 13 is a conceptual view showing an example of a RAID5 configuration.

FIG. 14 is a diagram showing an example of the configuration of a storage system in Example 3.

FIG. 15 is a diagram showing an example of an alternate block allocation method in Example 3.

FIG. 16 is a diagram showing an example of block management information in Example 3.

FIG. 17 is a diagram showing an example of the relationship between a virtual volume and a LDEV in Example 3.

FIG. 18 is a diagram showing an example of pool management information in Example 3.

FIG. 19 is a diagram showing an example of LDEV management information in Example 3.

FIG. 20 is a diagram showing an example of flash memory package management information in Example 3.

FIG. 21 is a diagram showing an example of an alternate block allocation method in a case where a global spare is used in Example 3.

FIG. 22 is a diagram showing an example of an alternate block allocation method in Example 4.

FIG. 23 is a flowchart of a process for allocating an alternate block in Example 5.

### DESCRIPTION OF EMBODIMENTS

An example of embodiments of the present invention will be explained below with reference to the figures.

### Example 1

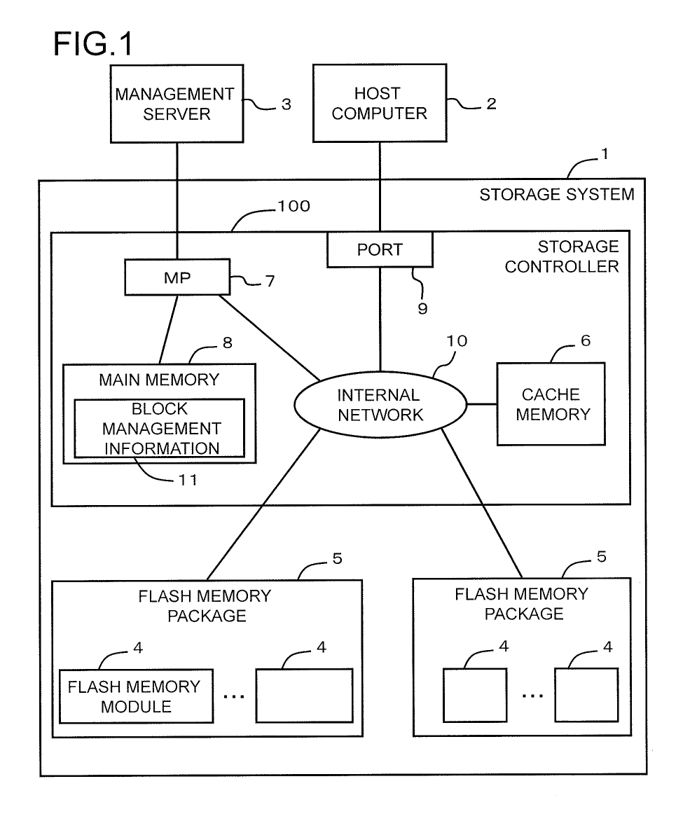

FIG. 1 is a diagram showing an example of the configuration of a storage system.

The storage system 1, for example, is a storage device comprising a plurality of flash memory modules. A host computer 2, which is one type of higher-level device, and which issues an I/O (Input/Output) request, and a management server 3, which is a computer for managing the storage system 1, are connected to the storage system 1. The storage system 1 has a plurality of flash memory modules 4 that store storage controllers 100 and data; and one or a plurality of flash memory packages 5 capable of mounting a plurality of flash memory modules 4. The storage controller 100 comprises a cache memory 6, which is a memory for caching data; one or more microprocessors (hereinafter notated as MP) 7 for controlling the storage system 1; a main memory 8 that holds data and programs for carrying out control; one or more ports 9 for exchanging data with the host computer 2; and an internal network 10 that interconnects the flash memory package 5, cache memory 6, port 9 and MP 7.

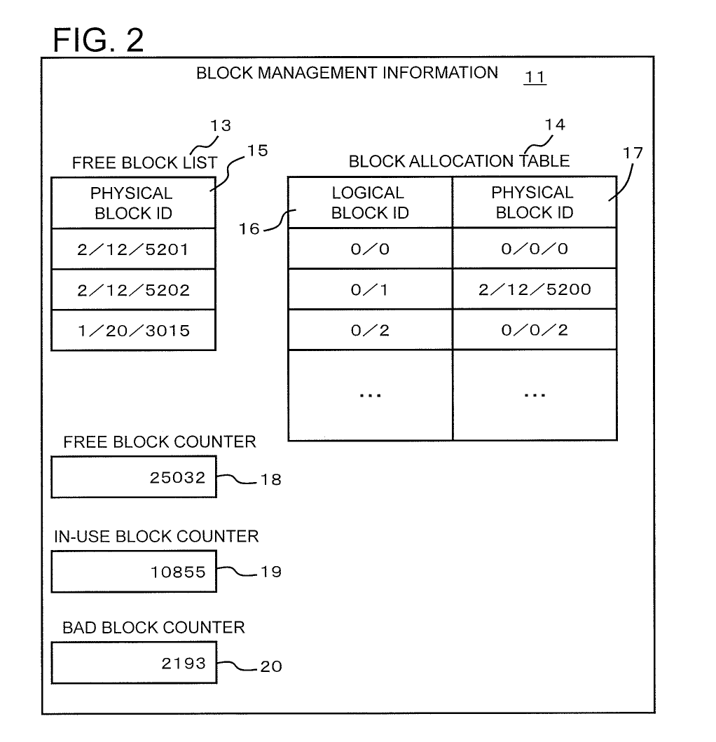

The flash memory module 4, for example, is a memory module, which is shaped like a DIMM (Dual Inline Memory Module), and which mounts a plurality of flash memory chips on a printed circuit board. Further, the flash memory package 5, for example, is a substrate comprising one or more slots for connecting a flash memory module 4; a control unit (LSI) for controlling access to a flash memory chip in the flash memory module 4; and a connector for connecting to the internal network 10 of the storage system 1. The main memory 8 stores block management information 11 for managing at least the blocks of a flash memory. An example of block management information 11 is shown in FIG. 2.

The block management information 11 comprises a free block list 13; block allocation table 14; free block counter 18; in-use block counter 19; and bad block counter 20. An in-use block here is one that is allocated as a data storage area, and comprises an alternate block. Further, a bad block is a block that has reached the limit for number of deletions, or is a block that cannot be used due to failure or the like. Furthermore, data cannot be written to a block that has reached the limit for number of deletions and has become of bad block, but it is possible to read out data from this block. A free block is a block other than the ones just described, that is, a free block is one that is usable and, in addition, is not being used.

The free block list 13 lists up the physical block IDs 15 of free blocks. The physical block ID 15 is an identifier for uniquely specifying a block in the storage system, and, for example, is expressed as a combination of a flash memory package number, a flash memory module number in the flash memory package, and a block number in the flash memory module.

The block allocation table 14 is a mapping table of logical block IDs 16 that denotes the location of blocks in a logical address space, and the physical block IDs 17 of the blocks allocated to this logical block. The logical block ID 16, for example, is represented by a combination of a device number and a block number in the device. The in-device block number, for example, is the quotient arrived at by dividing the addresses in the device by the block size.

The free block counter 18, in-use block counter 19 and bad block counter 20 are counters for respectively storing the number of free blocks, the number of used blocks, and the number of bad blocks in the storage system.

For example, when a block is allocated anew as a data storage area, the MP7 decrements the free block counter 18 by 1, and increments the in-use block counter 19 by 1. Further, when one block becomes unusable, and a free block is allocated as an alternate block, the MP7 increments the bad block counter 20 by 1 and decrements the free block counter 18 by 1.

Next, the alternate block allocation method will be described. In this example, when a bad block occurs, the storage controller allocates a free block as an alternate block, and when data had been stored in the original block, which became a bad block, the storage controller moves this data to the alternate block. Furthermore, when a bad block occurs due to a failure, it may not be possible to read out the data from the original block. In this case, for example, when a RAID (Redundant Arrays of Independent Disks) configuration is employed, the storage controller restores the lost data. The storage controller can use data and parity stored in another normal flash memory or magnetic disk to restore the data stored in the original block and write this data to the alternate block. Further, if it is backup data, the storage controller can copy the backup data to the alternate block. A configuration, which uses a plurality of flash memory packages 5 and forms a RAID configuration, will given as an example of the configuration of Example 2 further below.

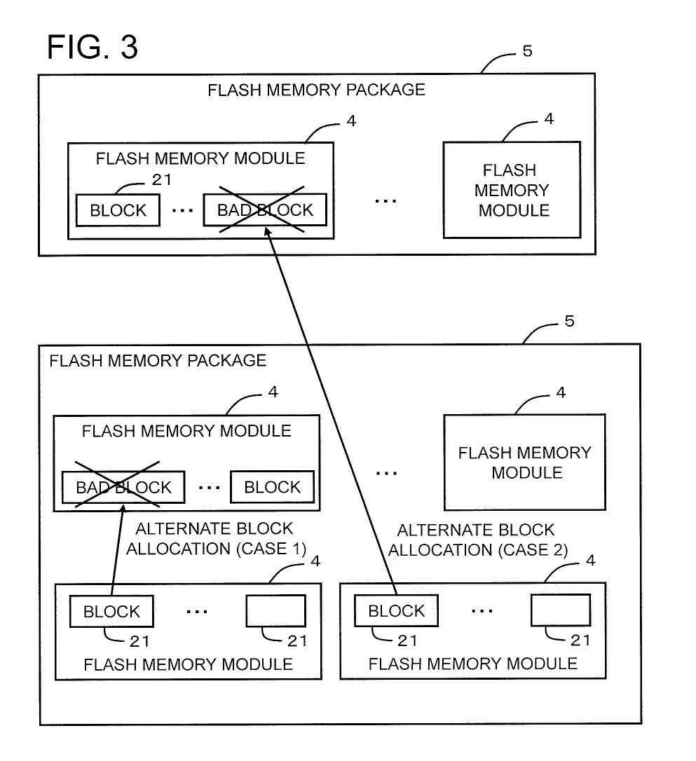

In this example, since control of all the flash memories in the storage system is carried out by the MP7 of the storage controller, as shown in FIG. 3, it becomes possible to allocate an arbitrary free block in the storage system as an alternate block. That is, like the example disclosed in FIG. 3, a block in a flash memory module that differs from the flash memory module to which the bad block belongs can be used as the alternate block (case 1), and a block in a flash memory module connected to a flash memory package that differs from the flash memory package connected to the flash memory module to which the bad block belongs can be used as the alternate block (case 2). Although not shown in the figure, an alternate block can also be selected from inside the flash memory module to which the bad block belongs. Furthermore, when a flash memory module 4 is augmented, the MP7 registers the block of the augmented flash memory module in the free block list 13, and increases the value of the free block counter 18 by the number of blocks that were added. Thereafter, when allocating an alternate block, a block registered in the free block list 13 can be allocated. Next, managing the free block capacity will be explained.

When there are no more free blocks in the storage system, it becomes impossible to allocate a free block as an alternate block when a bad block occurs. Accordingly, the MP7 manages the free block capacity in the system, issues a warning when the remaining free block capacity is insufficient, and urges the administrator to augment flash memory.

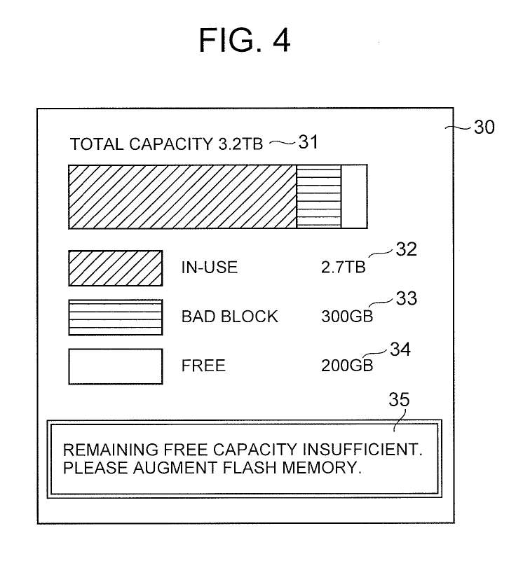

FIG. 4 is an example of a GUI (Graphical User Interface) for managing the flash memory capacity in the storage system. This GUI respectively displays the total capacity 31 of the flash memory mounted in the storage system 1; the total capacity 32 of the data-storing blocks (used) thereamong; the total capacity of the bad blocks 33; and the total capacity of the free blocks (free capacity) 34. Then, when the free capacity becomes insufficient, the GUI displays a message to that effect as a warning message in the message display area 35. Furthermore, means for issuing a warning are not limited to a warning message, and, for example, electronic mail or a syslog can also be used.

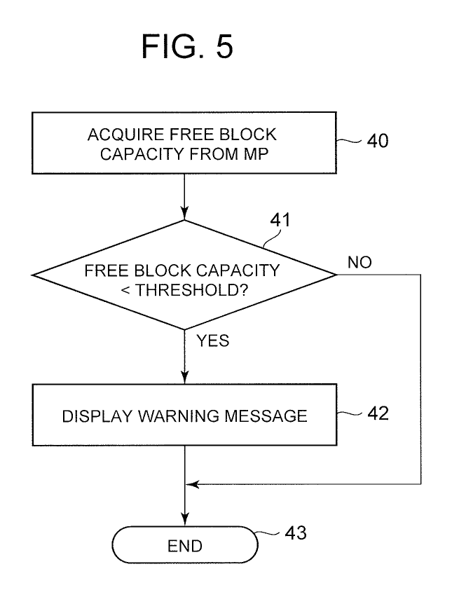

Next, FIG. 5 shows an example of a process in which the management server 3 checks the free capacity (free block capacity) 34 in the storage system, and displays a warning message. First, the management server 3 acquires the free block capacity 34 in the storage system from the MP7 (Step 40). Next, the management server 3 determines whether or not the free block capacity 34 is smaller than a predetermined threshold (Step 41). When the result of this determination is that the free block capacity 34 is smaller than the threshold, the management server 3 displays a warning message (Step 42), and ends processing (Step 43). When the free block capacity 34 is not smaller than the threshold (that is, when the free block capacity 34 is the threshold or greater), the management server 3 ends processing as-is.

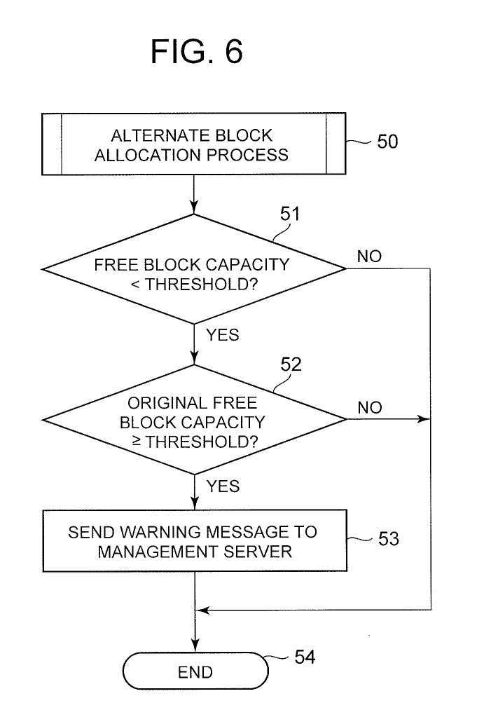

Furthermore, for example, a configuration in which the MP7 of the storage device independently checks the free block capacity 34, and sends a warning message to the management server 3 can also be used. The flowchart of FIG. 6 shows an example of the processing at that time. The MP7, after carrying out an alternate block allocation process (Step 50), determines whether or not the free block capacity 34 is smaller than the threshold (Step 51). When the free block capacity 34 is smaller than the threshold, the MP7 determines whether or not the free block capacity 34 was the threshold or greater prior to the alternate block allocation process (Step 52), and if this is true, sends a warning message to the management server 3 (Step 53). Furthermore, Step 52 is a determination for preventing the warning message from being sent repeatedly.

### Example 2

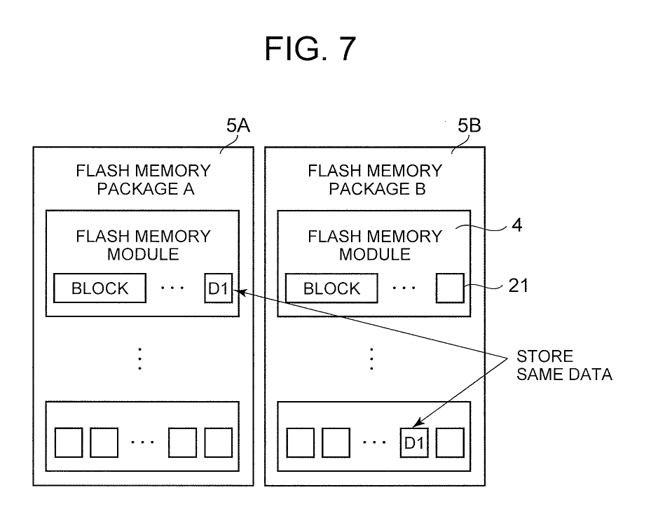

Example 2 of the present invention will be explained next based on FIGS. 7 through 13.

The configuration of the storage system 1 in this example is the same as in Example 1, and an example of this configuration is shown in FIG. 1.

As described for Example 1, the allocation of an alternate block for the storage system 1 can be carried out for an arbitrary block in the storage system 1, but in this example, the alternate block allocation range is limited to heighten the reliability of the system. As one example, a case in which a plurality of flash memory packages 5 are configured into a RAID system in preparation for a flash memory package 5 failure will be considered. As an example, it is supposed here that two flash memory packages 5A and 5B are used, and that a RAID1 (mirroring) configuration, which stores the same data in two blocks in different flash memory packages 5A and 5B respectively, is formed as in FIG. 7.

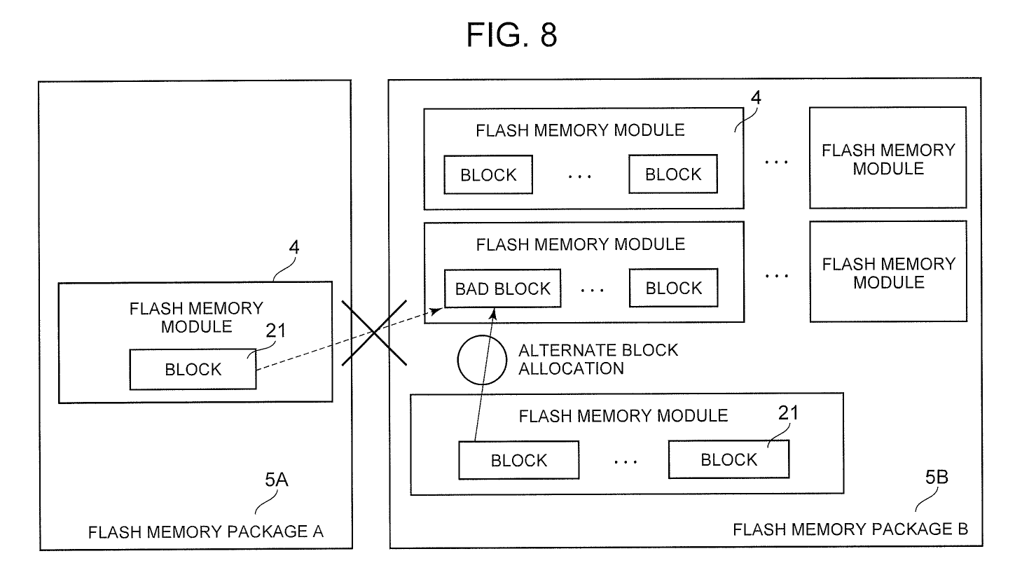

In this case, since the redundancy for flash memory package failure is lost when the two blocks that store the same data constituting the mirror pair are arranged in the same flash memory package. Consequently, when allocating an alternate block to a certain block, a free block in the same flash memory package as the original block (failed block) is allocated as the alternate block as shown in FIG. 8.

As described above, this example limits the allocation range of an alternate block, but it is possible to allocate an alternate block that spans a flash memory module 4, which is the augmentation unit. Therefore, even in a case where a flash memory module has been augmented to deal with an increase in bad blocks, it is possible to continue using the usable blocks inside the same flash memory package as-is. Therefore, this example also achieves the effect of efficient use of flash memory capacity the same as Example 1.

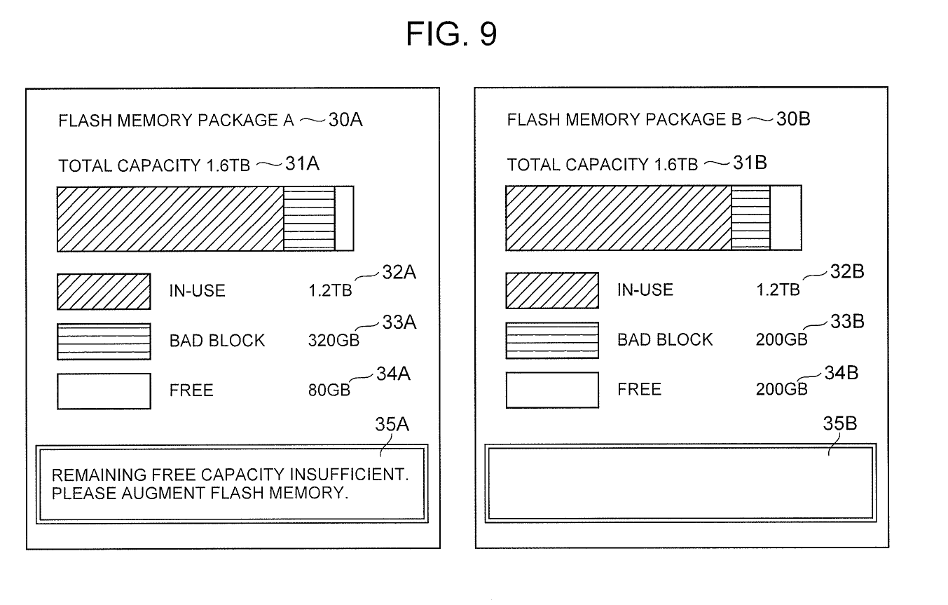

FIG. 9 shows an example of a GUI of this example. Since the allocation of an alternate block is limited to the inside of the flash memory package in this example, the management of flash memory capacity is carried out by each flash memory package as shown by 30A and 30B. Then, the warning message when the remaining free block capacity becomes insufficient is outputted for each flash memory package. In FIG. 9, since the remaining free block capacity 34A in flash memory package A shown on the left side has become insufficient, a warning message is displayed in the message display area 35A.

Furthermore, in this example, it is possible to remove the flash memory packages 5 one by one from the storage system 1, and to augment the flash memory modules 4 in the removed flash memory packages 5 while the storage system is in operation.

For example, a case where a flash memory module 4 is augmented in flash memory package A (5A) will be described. When a read command for data D1 is received from the host computer 2 while blocking and removing the flash memory package A (5A) from the storage system 1, the MP7 can read out the data D1 in flash memory package B (5B) and send this data D1 to the host computer 2. Further, when a write command for data D1 is received from the host computer 2, and this data is written to flash memory, the MP7 can update the data D1 in the flash memory package B (5B) using the data received from the host computer 2. Then, when flash memory package A (5A) in which flash memory module 4 augmentation ends, is reinstalled in the storage system 1, the MP7 can copy the data of the respective blocks in flash memory package B (5B) to corresponding blocks in flash memory package A (5A). This copying process is called a rebuild process.

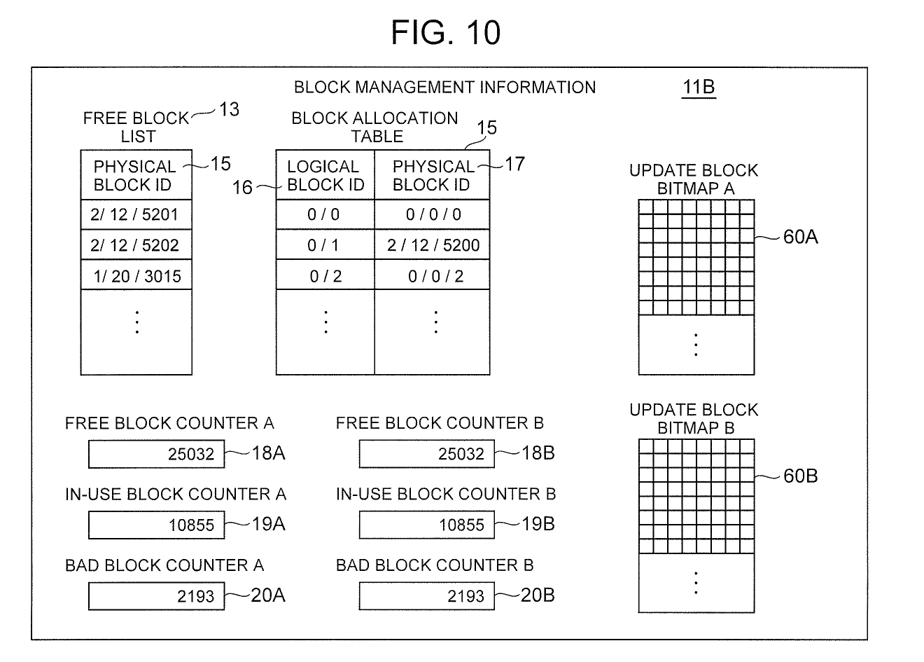

Furthermore, since the original data remains in flash memory package A (5A) at this time, it is not always necessary to rebuild flash memory package A (5A) in its entirety. For example, the MP7 can shorten rebuild time by using a bitmap or the like to record blocks corresponding to addresses for which a write has been carried out during flash memory augmentation, and then only rebuilding these updated blocks. FIG. 10 shows an example of block management information 11B, which adds an update block bitmap showing the presence or absence of a write to the respective blocks. Update block bitmap A (60A) is the update block bitmap for flash memory package A, and update block bitmap B (60B) is the update block bitmap for flash memory package B. Furthermore, different counters are used in flash memory package A and flash memory package B for the free block counter 18, in-use block counter 19 and bad block counter 20.

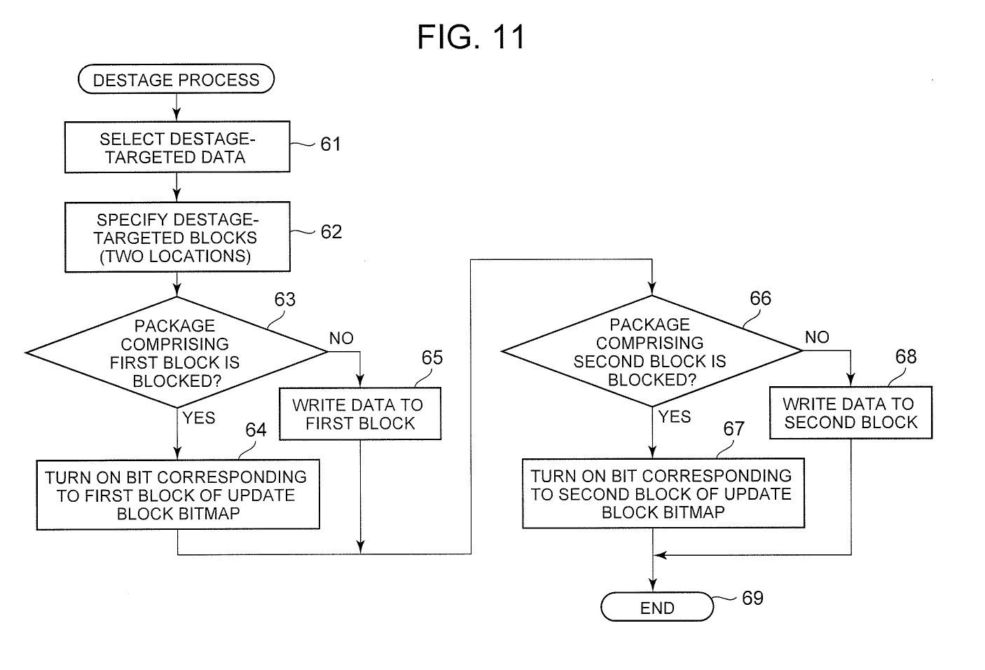

FIG. 11 shows a flowchart of a data write process to flash memory (destage process) comprising a process for recording an update location in this update block bitmap. First, the MP7 selects the data targeted for destaging (Step 61). Next, MP7 uses the block allocation table 14 to specify the physical blocks ID of the destage-targeted blocks where data is to be stored from the destage-destination device numbers and addresses (Step 62). Since mirroring takes place here, the physical block IDs of two different blocks are respectively specified.

Next, the MP7 determines whether or not the package comprising the first destage-targeted block is blocked (Step 63), and if this package is blocked, turns ON the bits corresponding to the first block of the update block bitmap (Step 64). If this package is not blocked, the MP7 writes the data to the first block (Step 65).

Next, the MP7 determines whether or not the package comprising the second destage-targeted block is blocked (Step 66), and if this package is blocked, turns ON the bits corresponding to the second block of the update block bitmap (Step 67). If this package is not blocked, the MP7 writes the data to the second block (Step 68).

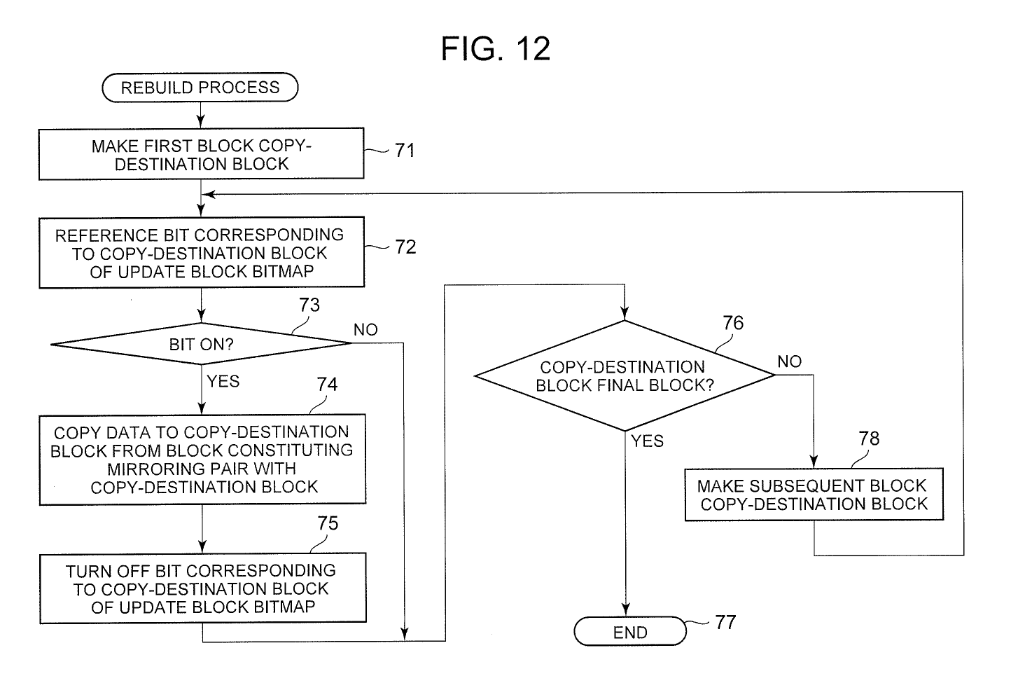

FIG. 12 is a flowchart of a rebuild process that uses the update block bitmap. First, the MP7 sets the first block comprised in the flash memory package 5 in which flash memory module 4 has been augmented, as the copy-destination block (Step 71). Then, the MP7 references the bit of the update block bitmap corresponding to the copy-destination block (Step 72). Next, the MP7 determines whether or not this bit is ON (Step 73), and if the bit is ON, the MP7 copies data to the copy-destination block from the copy-source block that constitutes the mirror pair (Step 74). The MP7 turns OFF the bit of the update block bitmap corresponding to the copy-destination block (Step 75). If the bit is OFF (“No” in Step 73), the MP7 skips Step 74 and Step 75, and proceeds to Step 76. Next, the MP7 determines whether or not the current copy-destination block is the final block in the flash memory package (Step 76), and if the copy-destination block is the final block, ends the rebuild process (Step 77). If the copy-destination block is not the final block in the flash memory package, the MP7 sets the subsequent block as the copy-destination block (Step 78), returns to Step 72, and continues processing.

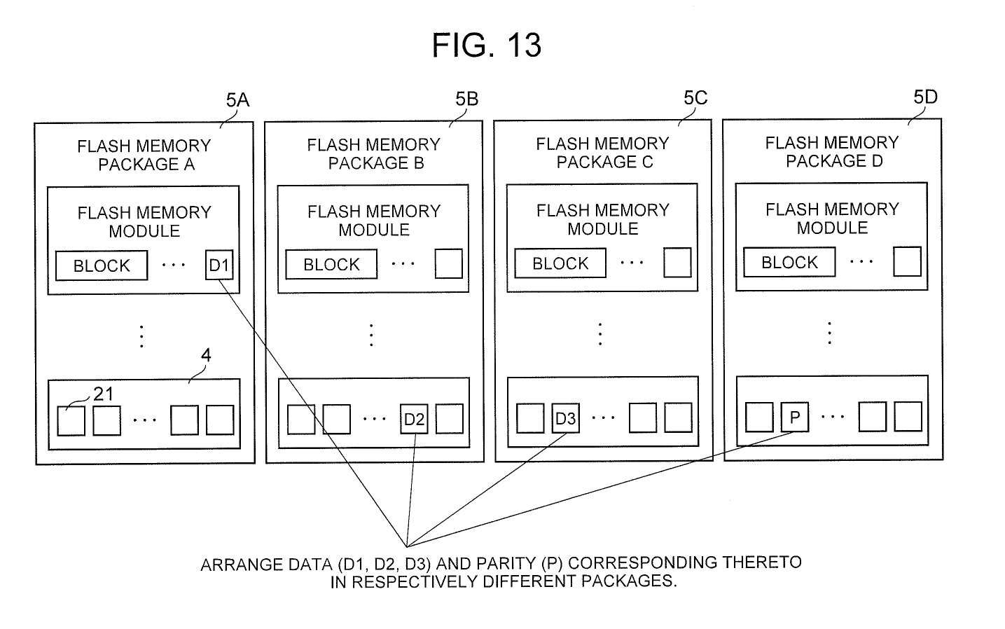

The preceding has described this example in the case of RAID1, but the embodiments of the present invention are not limited to this, and, for example, can also utilize a RAID5 or RAID6 configuration. For example, in the case of a RAIDS (3D+1P), data (D1, D2, D3) and the parity (P) corresponding thereto can be arranged in respectively different flash memory packages 5A to 5D as in FIG. 13. Naturally, when carrying out a rebuild process, or when a read or write has been received from the host, unlike in RAID1, the data and parity are created using a parity operation.

Further, in this example, a flash memory package is given as an example of an alternate block allocation range, but the embodiments of the present invention are not limited to this so long as redundancy is improved compared with when the entire storage system is used as the allocation range. Consequently, the storage controller can split the storage system into a plurality of partitions using an arbitrary condition, and the allocation of an alternate block can be restricted solely to the inside of each partition. For example, it is also possible to set a range partitioned by the power source boundary or storage device enclosure as the alternate block allocation range (that is, the partition).

Furthermore, in Examples 1 and 2, the configuration is such that flash memory modules 4 are mounted in a flash memory package to facilitate the augmentation of flash memory in the storage system, but the embodiments of the present invention are not limited to this, and, for example, a configuration that stores the substrate on which the flash memory chip is mounted in a box-shaped memory cartridge, and connects this memory cartridge to the storage device can also be used.

### Example 3

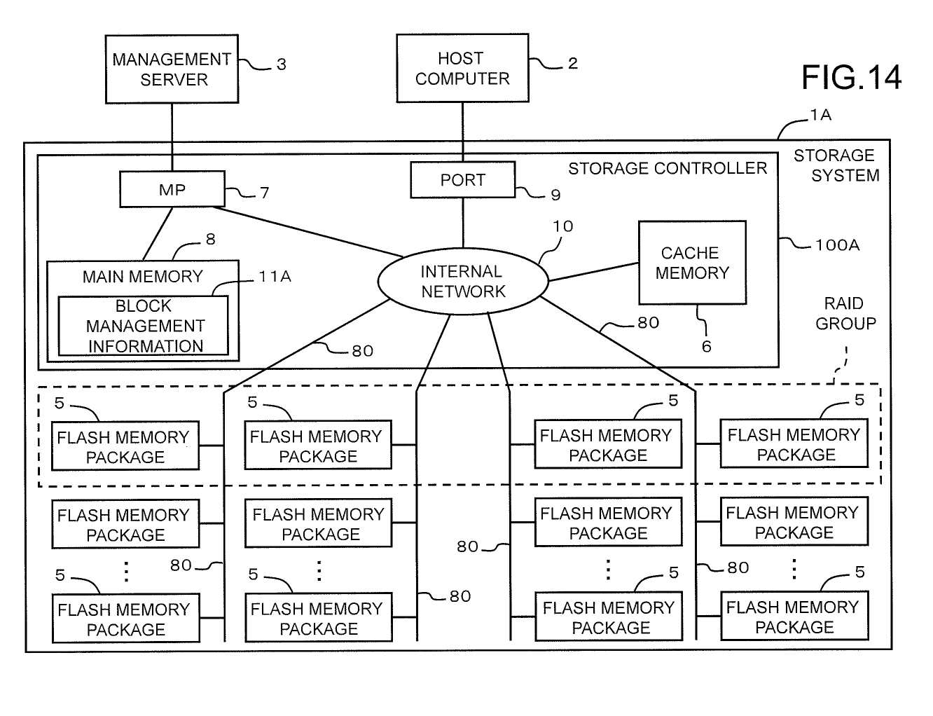

Next, Example 3 of the present invention will be explained based on FIGS. 14 through 21. FIG. 14 is a diagram showing the configuration of a storage system in this example. In this example, it is supposed that a plurality of flash memory packages 5 is able to be respectively connected to a plurality of data transfer paths (back-end paths 80) provided in the storage system 1. Using a configuration like this facilitates the connection of a large quantity of flash memory, making it easy to increase the capacity of the storage system.

For example, by connecting an augmentation enclosure to a main enclosure, it is possible to achieve a configuration in which the storage capacity of the storage system 1 is able to be increased and decreased in stages. In accordance with this, a storage controller 101A (the storage controller 101A, for example, comprising a MP 7, a main memory 8, a cache memory 6, a port 9, and an internal network 10) and either one or a plurality of flash memory packages 5 are disposed inside the main enclosure. Another plurality of flash memory packages 5 are disposed inside either one or a plurality of augmentation enclosures. Therefore, it is possible to increase and decrease the storage capacity in augmentation enclosure units. In addition, by adjusting the number of flash memory packages 5 disposed inside the augmentation enclosure, it is possible to increase and decrease the storage capacity in flash memory package units. Furthermore, by adjusting the number of flash memory chips 4A inside the flash memory package 5, it is also possible to increase and decrease the storage capacity in flash memory chip units.

In this example, one flash memory package 5 each is selected from two or more back-end paths 80, and these selected flash memory packages 5 are used to configure a RAID group. Furthermore, in FIG. 14, as an example, four back-end paths 80 are used to configure a RAID group from four flash memory packages 5 that are in the same location on each back-end path 80, but the number of back-end paths 80 and the physical relationship of the flash memory packages 5 are not limited to the above-described example. Also, a case of RAID5 will be described here as an example, but the same method is also able to be used for another RAID level, such as a RAID6 or a RAID1.

The host computer 2, the management server 3, the cache memory 6, the MP 7, the main memory 8, the port 9, and the internal network 10 in FIG. 14 are the same as those of Example 1 shown in FIG. 1. The contents of the block management information 11A in this example will be explained further below.

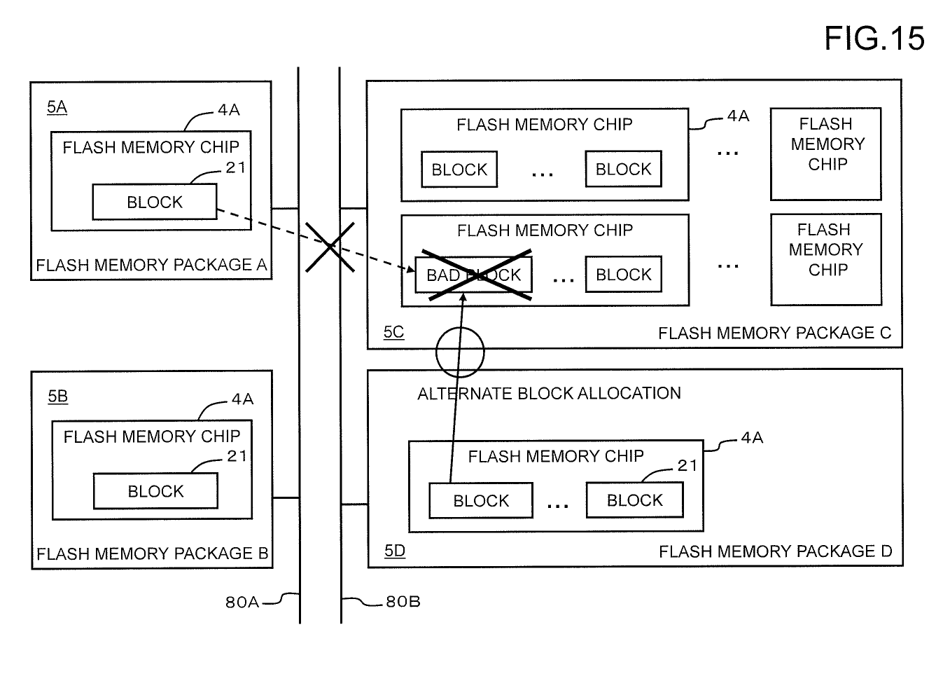

In this example, as shown in FIG. 15, the allocation range of the alternate block will be limited to the block inside the flash memory package 5D connected to the same back-end path 80B as the flash memory package 5C comprising the original block (the bad block). By so doing, even when a certain back-end path 80 has failed, it will be possible to restore and allow the host computer 2 access to the data stored in the bad block by using the data and the parity inside another normal block.

The above-mentioned example considers a case in which the back-end path 80B to which both the flash memory package 5C having the bad block and the flash memory package 5D having the alternate block are connected has failed. In accordance with this, it is not possible to access the data inside the alternate block, but it is possible to access other respective data and parity belonging to the same stripe (parity row) as the data inside the alternate block. Therefore, it is possible to restore the data stored in the alternate block and provide this data to the host computer 2 in accordance with the so-called correction copy technique.

A case in which a block inside the flash memory package 5A, which is connected to a back-end path 80A that differs from the back-end path 80B, to which the flash memory package 5C having the bad block is connected, is used as the alternate block will be considered. In accordance with this, in a case where the back-end path 80A, which is the connection destination of the flash memory package 5A having the alternate block, fails, it is impossible to access the data inside this alternate block. Not only that, but since it is also impossible to access a portion of either the other respective data or parity belonging to the same parity row as the data inside the alternate block, a so-called double failure occurs, making it impossible to deal with this situation using a RAID5 correction copy.

That is, the respective data and parity that belong to the same parity row must be distributively arranged in the respective flash memory packages 5 connected to the respectively different back-end paths. In a case where this is not so, a plurality of either the respective data or parity belonging to the same parity row will become correspondent to one another. In a case where a failure has occurred in this back-end path, it is not possible to use the data recovery technique in accordance with RAID5. In the case of RAID6, it is possible to cope with a double failure as well since two parities are used. However, it is not possible to cope with this double failure in a case where a failure occurs in the reading out of either three or more data or parities. Therefore, in the case of RAID6, it is also possible to enhance the reliability of the storage system 1 that uses flash memory by applying the above-mentioned RAID5.

Furthermore, this example gives an example in which the flash memory chip 4A is directly mounted in the flash memory package 5, but the configuration may also connect a flash memory module 4 to the flash memory package 5 the same as in Examples 1 and 2.

Furthermore, as explained below, in a case where an alternate block allocation is carried out spanning the flash memory packages 5, the configuration may be such that the parity row is transferred at the same time so that the data/parity set (will be called the parity row below) is arranged in the same RAID group. By so doing, it is possible to contain the affected range in a case where a certain flash memory package 5 fails to the inside of the RAID group to which the failed flash memory package 5 belongs.

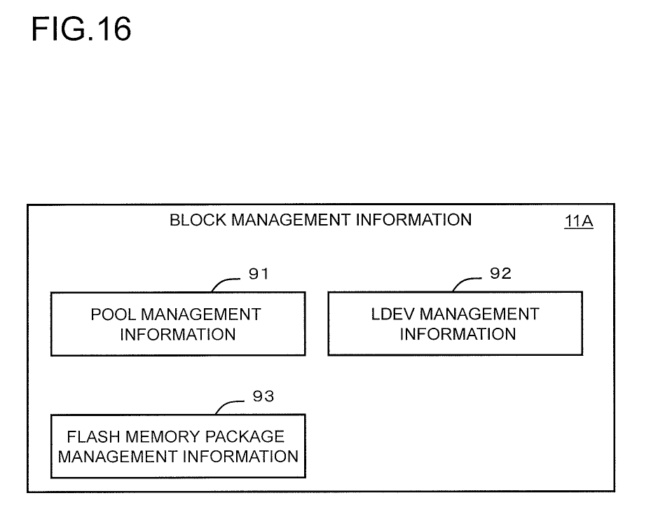

FIG. 16 shows an example of the block management information 11A in this example. For example, the block management information 11A comprises pool management information 91, LDEV management information 92, and flash memory package management information 93.

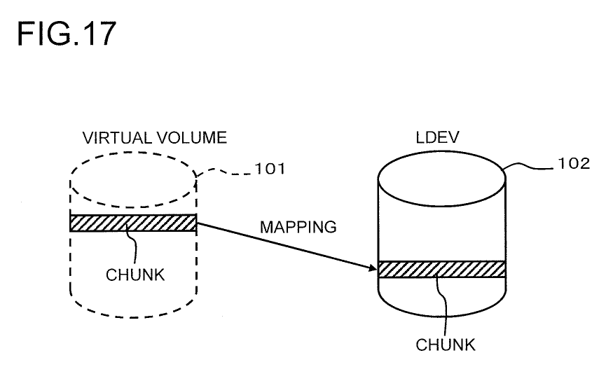

In this example, management is carried out by dividing the logical device (LDEV) 102 into small areas (chunks) and mapping chunks of the virtual volume 101 to these chunks as shown in FIG. 17. The host computer 2 recognizes this virtual volume 101 as the LU (Logical Unit), and performs reading and writing with respect to the virtual volume 101. The storage system 1, in response to a read/write request from the host computer 2, either reads out the data from the address on the LDEV 102 corresponding to the address of the virtual volume 101 that was accessed and returns this data to the host computer 2, or writes the write data received from the host computer 2 to this address.

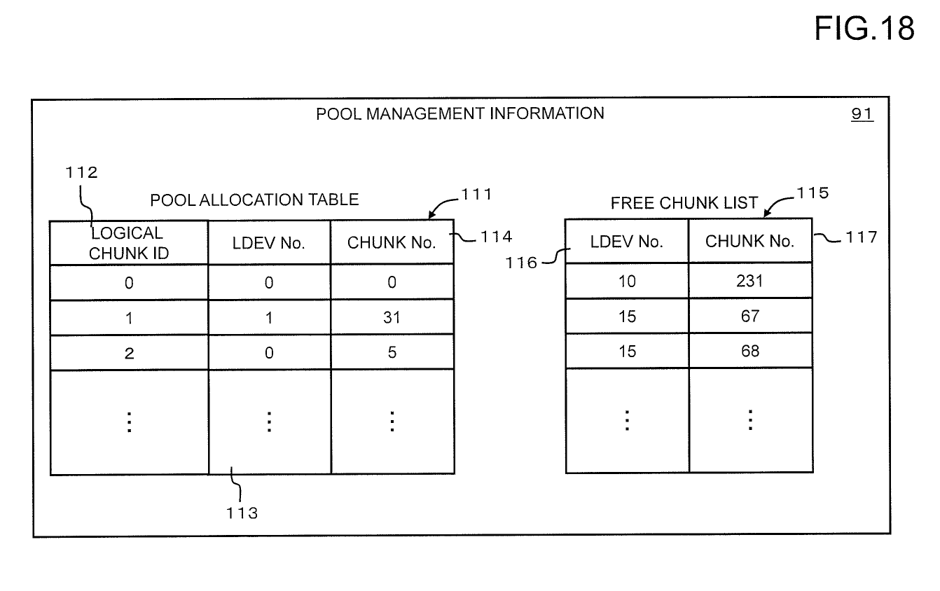

FIG. 18 shows an example of pool management information 91 in this example. The pool management information 91 comprises a pool allocation table 111 and a free chunk list 115. The pool allocation table 111 is a table for managing the mapping of the chunks inside the LDEV 102. This pool allocation table 111 comprises an identifier 112 for identifying each chunk inside the virtual volume 101, a number 113 of the LDEV to which each chunk on the virtual volume has been mapped, and a number 114 of the chunk inside the LDEV. The free chunk list 115 is a list for managing a chunk that has not been allocated to the virtual volume 102 (that is, a free chunk). This free chunk list 115 comprises a LDEV number 116 and a chunk number 117.

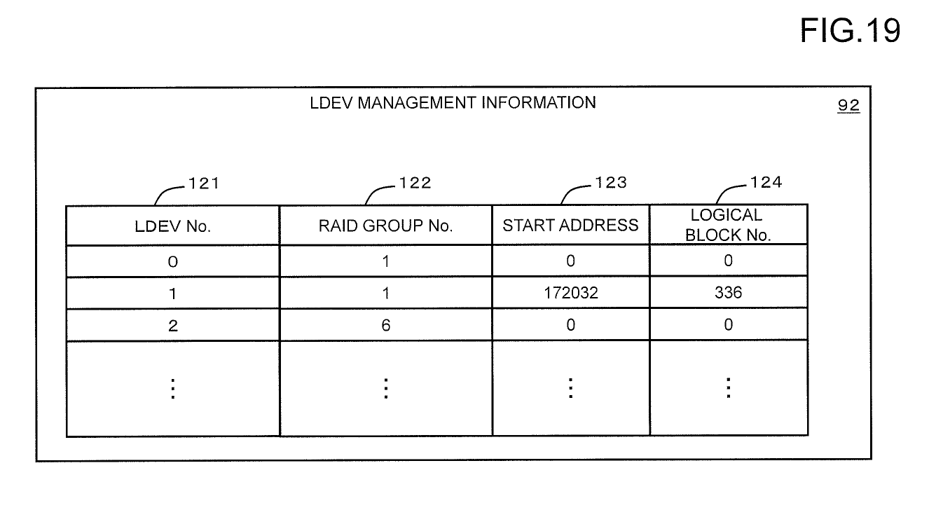

FIG. 19 shows an example of the LDEV management information 92. The LDEV management information 92 comprises a number 121 for each LDEV 101, a number 122 of the RAID group in which each LDEV 102 is included, a start address 123 for the LDEV in the RAID group, and a logical block number 124 for the LDEV start location. The start address 123 and logical block number 124 of the start location inside the LDEV use different modes of expression, but both point to the same location. For ease of understanding, the start address 123 and the start location logical block number 124 are lined up together here.

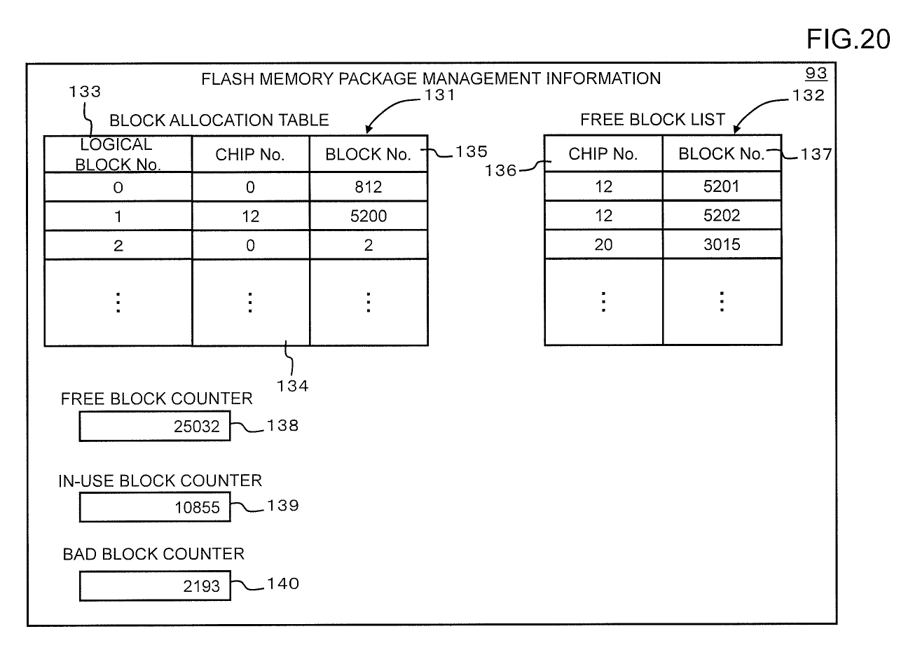

FIG. 20 shows an example of the flash memory package management information 93. The flash memory package management information 93, for example, comprises a block allocation table 131, a free block list 132, a free block counter 138, an in-use block counter 139, and a bad block counter 140.

The block allocation table 131 is a table for showing the correspondence among a logical block number 133 denoting the location of a block in a logical address space, a number 134 of a flash memory chip belonging to the block to which this logical block has been allocated, and a block number 135. The logical block number 133, for example, is the quotient obtained by dividing the logical addresses inside the LDEV by the size of the block. The chip number 134, for example, is the number of a unique flash memory chips 4A inside the flash memory package 5. The block number is, for example, the quotient obtained by dividing the addresses inside the flash memory chip 4A by the size of the block.

The free block counter 138 is the counter for storing the number of empty blocks inside the flash memory package 5. The in-use block counter 139 is the counter for storing the number of blocks that are being used inside the flash memory package 5. The bad block counter 140 is the counter for storing the number of bad blocks inside the flash memory package 5.

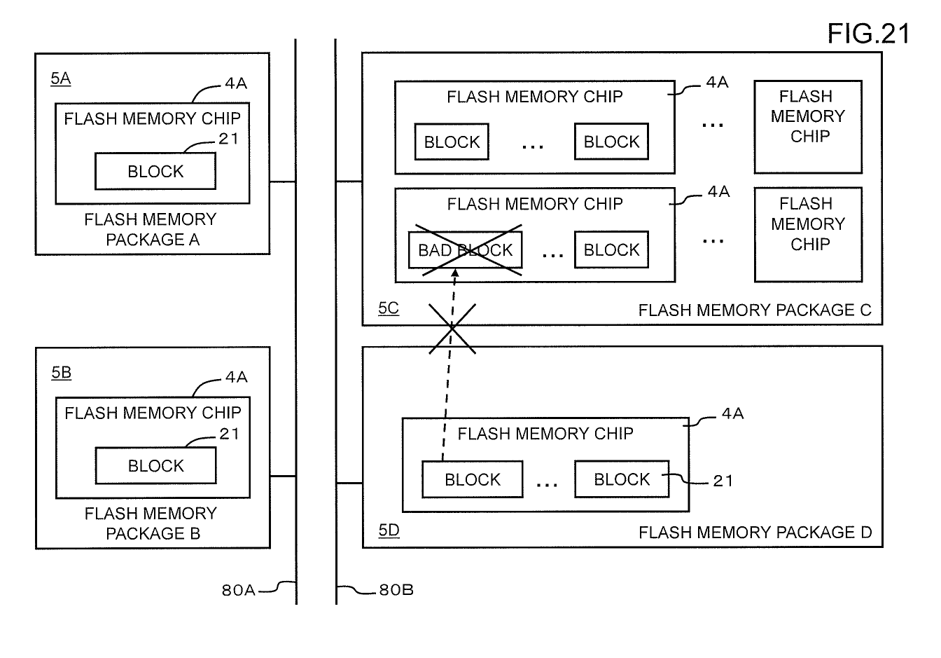

As shown in FIG. 21, the configuration may be such that a spare flash memory package 5D is provided beforehand to enhance the reliability of the storage system. In a case where a certain flash memory package fails, all the data in this failed flash memory package is able to be transferred to this spare flash memory package 5D.

For example, in the case of RAID5, the data stored in the failed flash memory package is restored by using the data and parity stored in another flash memory package inside the RAID group, and this restored data is written to the spare flash memory package. Or, the data inside the original flash memory package may be copied to the spare flash memory package prior to the data from the relevant flash memory package becoming unreadable.

It is also possible to dispose a different spare flash memory package to each back-end path 80. However, since the number of spare flash memory packages will increase in accordance with this, the cost of implementing the storage system will increase.

It is also possible for a single spare flash memory package to be shared in common by all the back-end paths 80. This approach will be called the global spare method here. In a case where the global spare method is used, the number of spare flash memory packages is minimized, making it possible to reduce the initial implementation costs of the storage system.

So as to be able to store all the data stored in a failed flash memory package in a case in which the global spare method is employed, the global spare flash memory package must have free capacity equivalent to at least one normal flash memory package.

Further, in order to enhance the reliability of the storage system, it is preferable that the data stored in a flash memory package that is connected to respectively different back-end paths not be mixed together in the global spare flash memory package. That is, in a case where the data and so forth (the data and parity will be called the data and so forth) that belong to respectively different parity rows is collected together into a single global spare flash memory package, redundancy is lost, raising fears that storage system reliability will deteriorate.

For this reason, as shown in FIG. 21, the storage controller does not allocate a block inside the global spare flash memory package as an alternate block for a bad block in this example. In other words, this example uses the global spare flash memory package as a replacement package for a normal flash memory package, which is the original purpose thereof. Therefore, each free block inside the global spare flash memory package is constituted so as not to be selected as an alternate block.

In a case where a failed flash memory package is replaced with a new flash memory package, the data saved to the spare flash memory package is copied to the new flash memory package. Then, the new flash memory package to which the data has been copied is used. Subsequent to completion of the data copy, the global spare flash memory package is able to be used as a spare for another flash memory package. Configuring this example like this also achieves the same effect as each of the above-mentioned examples. Furthermore, the above-described effect is achieved on the basis of the characteristic configuration of this example.

### Example 4

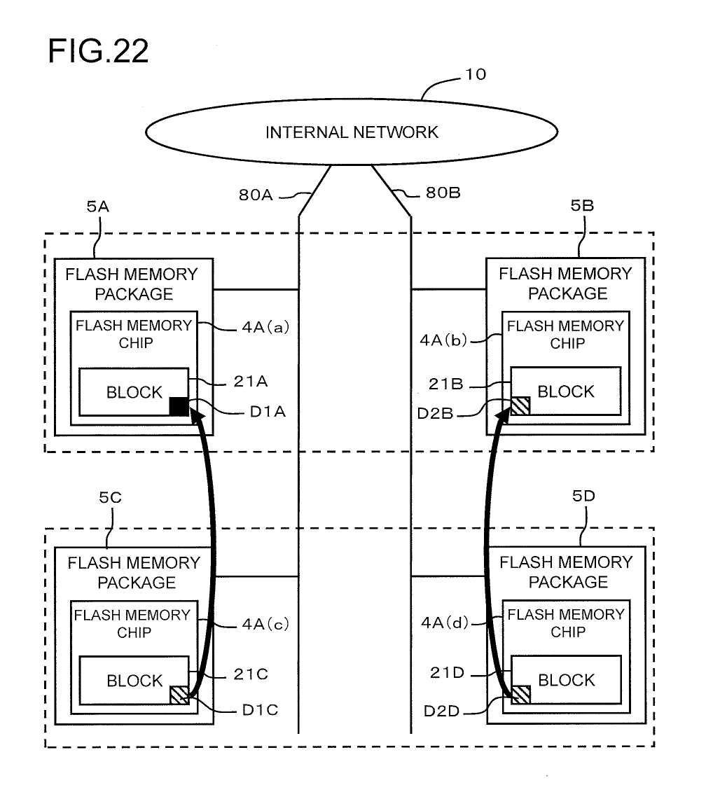

FIG. 22 is a diagram schematically showing how an alternate block is allocated in a storage system related to Example 4. For the sake of convenience, only two pieces of data are included in one parity row in FIG. 22, but in actuality, three or more pieces of data and parity will be included. In this example, in a case where a failure (an unwritable failure) occurs in a block 21A that stores a certain piece of data D1A, another block 21C that exists on the same back-end path 80A is used as the alternate block.

Furthermore, another alternate block 21D that exists on the same back-end path 80B is allocated to another block 21B that stores another piece of data D2B belonging to the same parity row (row of stripes) as the data D1A stored in the bad block 21A.

In other words, in this example, in a case where data belonging to a certain parity row is transferred to an alternate block so as not to disturb the parity row, the other data and so forth belonging to this parity row are also respectively transferred to the appropriate alternate block. Simply stated, the blocks in the parity row are moved in parallel. In accordance with this, it is possible to minimize the probability of a data loss occurring due to two or more flash memory packages failing.

For example, in a case where a failure occurs in the flash memory package 5C, it is possible to restore the data inside the flash memory package 5C by using another flash memory package 5D belonging to the same RAID group as this flash memory package 5C. Even in a case in which a failure occurs in a flash memory package (for example 5B) belonging to another RAID group prior to the restoration of the data inside the flash memory package 5C being completed, it is possible to continue restoring the data inside the flash memory package 5C.

By contrast, in a case in which only the data inside the bad block is transferred to an alternate block belonging to another RAID group without the respective data and so forth belonging to the parity row being moved in parallel at all will be considered. In a case where a failure occurs in the flash memory package 5C having this alternate block, correction copy and other such processing is also executed for the flash memory package 5B belonging to the transfer-source RAID group in addition to the flash memory package 5D that belongs to the same RAID group as this flash memory package 5C. In a case where a failure occurs in the flash memory package 5B prior to the restoration of the data inside the flash memory package 5C being completed, a double failure occurs making a loss of data likely. For this reason, in a case where data belonging to a certain parity row is transferred to the alternate block in this example, other data and so forth belonging to this parity row are also respectively transferred to the appropriate alternate block. Configuring this example like this also achieves the same effect as Example 3.

### Example 5

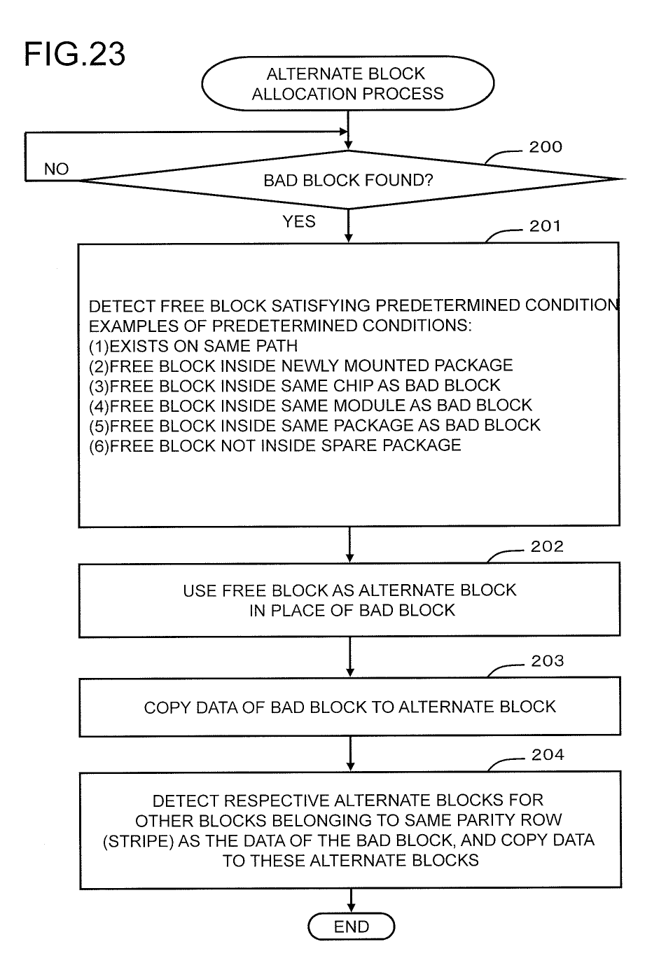

Example 5 will be explained on the basis of FIG. 23. FIG. 23 is a flowchart showing an alternate block allocation process related to this example. This process is executed by the MP 7. The MP 7 monitors whether or not a bad block has been generated (Step 200). A bad block is either an unwritable block, or a block that has a high likelihood of becoming unwritable.

When a bad block is detected, the MP 7 detects a free block that satisfies a predetermined condition (Step 201). As predetermined conditions, for example, it is possible to cite the following examples.

(Condition 1) A free block that exists on the same back-end path.

(Condition 2) A free block inside a newly mounted flash memory package.

(Condition 3) A free block that belongs to the same flash memory chip as the bad block.

(Condition 4) A free block that belongs to the same flash memory module as the bad block.

(Condition 5) A free block that belongs to the same flash memory package as the bad block.

(Condition 6) A free block that is not inside the global spare flash memory package.

The MP 7 selects as the alternate block a free block that agrees with either any one condition or a predetermined plurality of conditions from among the above-mentioned conditions 1 through 6, and allocates this alternate block to the bad block (Step 202). The MP 7 copies the data inside the bad block to the alternate block (Step 203).

Furthermore, as described with respect to Example 4, the MP 7 also selects appropriate alternate blocks for the other blocks that store other data and so forth belonging to the same parity row as the data inside the bad block, and transfers the other data and so forth to the appropriate alternate blocks (Step 204). Configuring this example like this also achieves the same effect as Examples 3 and 4.

Furthermore, in Examples 3 through 5, the configurations are such that one back-end path each is connected to each flash memory package, but in order to enhance reliability yet further, a plurality of back-end paths may be connected to each flash memory package.

Furthermore, in the above-mentioned examples, the cache memory 6 and main memory 8 were shown as separate memories, but the present invention is not limited to this, and, for example, the data written from the host computer 2, the programs, and the data for control may be stored in the same memory.

### REFERENCE SIGNS LIST

1, 1A Storage system

2 Host computer

3 Management server

4 Flash memory module

5 Flash memory package

6 Cache memory

7 Micro Processor (MP)

8 Main memory

9 Port

10 Internal network

11 Block management information

13 Free block list

14 Block allocation table

15 Physical block ID

16 Physical block ID

17 Physical block ID

18 Free block counter

19 In-use block counter

20 Bad block counter

21 Block

30 Management GUI display area

31 Total capacity of flash memory

32 Capacity of block in use

33 Bad block capacity

34 Free block capacity

35 Message display area

60 Update block bitmap

80 Back-end path

91 Pool management information

92 LDEV management information

93 Flash memory package management information

100, 100A Storage controller

101 Virtual volume

102 LDEV

111 Pool allocation table

112 Free chunk list

1. A storage system, comprising:
a storage controller;
and one or a plurality of flash memory modules connected to the storage controller,
wherein the one or the plurality of flash memory modules each have one or a plurality of flash memory chips,
the storage controller manages the status of a storage area in the flash memory chip of the one or the plurality of flash memory modules, and
when a portion of a storage area in the flash memory chip of the one or the plurality of flash memory modules becomes unwritable, the storage controller carries out control so as to select a free storage area from inside the flash memory chip of the one or the plurality of flash memory modules and use the free storage area as an alternate area for the portion of the storage area that has become unwritable, and to store data that has been stored in the portion of the storage area that has become unwritable, in the alternate area.

2. The storage system according to claim 1, further comprising:
a flash memory package that has a plurality of connectors which are connected to the storage controller and each of which is connected to any of the one or the plurality of flash memory modules, and that has an LSI that controls access to the flash memory chip in the flash memory module, which is connected via the connector, and
when a new flash memory module is connected to any of the plurality of connectors of the flash memory package, the storage controller selects the alternate area from among the storage areas in one or a plurality of flash memory chips of the new flash memory module.

3. The storage system according to claim 2, wherein the storage controller has a memory that records the status of the storage area in the flash memory chip of the one or the plurality of flash memory modules, and
when the new flash memory module is connected to the flash memory package, the storage controller acquires information showing the status of the storage areas in one or a plurality of flash memory chips of the new flash memory module, and stores the information in memory.

4. The storage system according to claim 2, wherein the storage controller manages the total size of the free storage areas in the flash memory chip of the one or the plurality of flash memory modules, and
when the total size satisfies a predetermined condition, the storage controller outputs a warning to add the new flash memory module to the flash memory package.

5. The storage system according to claim 1, wherein the storage controller selects a free storage area from among the storage areas that satisfy a predetermined condition, and uses the free storage area as the alternate area for the portion of the storage area that has become unwritable.

6. The storage system according to claim 5, wherein the storage controller selects the alternate area from among the storage areas in the flash memory chip of the flash memory module to which the portion of the storage area that has become unwritable belongs.

7. The storage system according to claim 1, wherein the storage controller splits the storage area in the flash memory chip of the one or the plurality of flash memory modules into a plurality of partitions, and selects the alternate area from among the free storage areas belonging to the same partition as a partition to which the portion of the storage area that has become unwritable belongs.

8. The storage system according to claim 7, wherein the storage controller manages the total size of the free storage areas in the partition for the each partition.

9. The storage system according to claim 1, comprising a plurality of flash memory modules, wherein the storage controller uses the plurality of flash memory modules to configure a RAID group.

10. The storage controller according to claim 9, comprising:
a plurality of flash memory packages each having a connector which is connected to the storage controller and is connected to any of the plurality of flash memory modules, and an LSI that controls access to the flash memory chip in the flash memory module connected to the connector,
wherein the storage controller uses the plurality of flash memory modules connected to respectively different flash memory packages to configure the RAID group.

11. The storage system according to claim 1, wherein the storage controller is connected to a management server, and
the storage controller manages the total size of the free storage areas in the flash memory chip of the one or the plurality of flash memory modules, and outputs to the management server information showing the total size.

12. The storage system according to claim 11, wherein the storage controller further manages the total size of the storage areas in use in the flash memory chip of the one or the plurality of flash memory modules, and the total size of the storage areas that have become unwritable, and outputs to the management server information showing the total size of the storage areas in use and the total size of the storage areas that have become unwritable.

13. A storage system according to claim 5, wherein the storage controller selects the alternate area from the storage area on the flash memory chip of the flash memory package connected to the same back-end path as the portion of the storage area that has become unwritable.

14. A method for controlling a storage system having one or a plurality of flash memory modules,
the one or the plurality of flash memory modules respectively comprising one or a plurality of flash memory chips,
the storage system control method comprising the steps of:
managing the status of a storage area in the flash memory chip of the one or the plurality of flash memory modules;
selecting a free storage area from inside the flash memory chip of the one or the plurality of flash memory modules in a case where a portion of a storage area in the flash memory chip of the one or the plurality of flash memory modules becomes unwritable;
using the selected free storage area as an alternate area for the portion of the storage area that has become unwritable; and
storing data that has been stored in the portion of the storage area that has become unwritable, in the alternate area.
